(19) United States
(12) Patent Application Publication
(10) Pub. No.: US 2025/0171603 A1
(43) Pub. Date: May 29, 2025

(54) STRETCHABLE FILM AND STRETCHABLE WIRING BOARD USING SAME

(71) Applicant: Panasonic Intellectual Property Management Co., Ltd., Osaka (JP)

(72) Inventors: Takatoshi ABE, Osaka (JP); Qianying LI, Osaka (JP); Tomohiro FUKAO, Santa Clara, CA (US)

(73) Assignee: Panasonic Intellectual Property Management Co., Ltd., Osaka (JP)

(21) Appl. No.: 18/958,749

(22) Filed: Nov. 25, 2024

(30) Foreign Application Priority Data
Nov. 28, 2023 (JP) 2023-200522

(51) Int. Cl. C08J 7/04; C08K 5/3492

(52) U.S. Cl. CPC C08J 7/0423; C08K 5/3492; C08J 2333/10

(57) ABSTRACT

The present invention relates to a stretchable film formed by using a resin composition containing an acrylic resin (A) and a curing agent (B). The stretchable film has an ultraviolet absorbance at 355 nm of 1.5 or more at a thickness of 100 μm, the stretchable film has a glass transition temperature of 0° C. or higher and lower than 50° C., and in the resin composition, the acrylic resin (A) contains a polymerization unit (a1) of a (meth)acrylate having an epoxy group and a polymerization unit (a2) of a (meth)acrylate having one or more non-epoxy groups, and the acrylic resin (A) has a weight average molecular weight of 50,000 or more and 3,000,000 or less.

### FIELD OF INVENTION

The present invention relates to a stretchable film and a stretchable wiring board using the same.

### BACKGROUND ART

In recent years, further miniaturization and high integration have been required for circuit boards used for various electric devices. In order to meet such needs, a multilayer wiring board in which a circuit board is multilayered is provided.

As a method for producing a multilayer wiring board, a build-up type producing method is known. In this method, a film having insulating properties is laminated on a circuit board, the film is cured, and then a via hole is formed using laser processing or the like. As a technique for improving laser processability at that time, it has been reported that a resin composition containing a specific styrene-based polymer, a specific inorganic filler, and a curing agent at a specific ratio is used (JP 2018-135506 A), and films containing a fluororesin or a thermosetting resin and an inorganic filler having a predetermined specific surface area as an ultraviolet absorbing substance at a specific ratio (JP 4224290 B2 and WO 2013/005847 A) are used.

Devices and board materials used in the electronics field, particularly in various interfaces such as sensors, displays, and artificial skin for robots are increasingly demanded to exhibit mountability and shape followability. There is a growing demand for flexible devices and materials that can be disposed on curved or uneven surfaces or can be freely deformed depending on the application.

The techniques described in JP 2018-135506 A, JP 4224290 B2, and WO 2013/005847 A are techniques focusing on laser processability of a multilayer wiring board, but the resins disclosed in JP 2018-135506 A, JP 4224290 B2, and WO 2013/005847 A have a high elastic modulus and poor stretchability. When the inorganic filler used as the ultraviolet absorbing substance in the techniques described in JP 2018-135506 A, JP 4224290 B2, and WO 2013/005847 A is highly filled in the resin composition, the elastic modulus further increases, and sufficient stretchability cannot be obtained.

The present invention has been made in view of such circumstances, and an object thereof is to provide a film material that can be used for a stretchable substrate excellent in followability and is also excellent in laser processability.

### SUMMARY OF THE INVENTION

As a result of intensive studies, the present inventors found out that the problems can be solved by the following configuration, and completed the present invention by conducting further studies based on this finding.

That is, a stretchable film according to one aspect of the present invention is formed by using a resin composition containing an acrylic resin (A) and a curing agent (B). The stretchable film has an ultraviolet absorbance at 355 nm of 1.5 or more at a thickness of 100 μm. The stretchable film has a glass transition temperature of 0° C. or higher and lower than 50° C. In the resin composition, the acrylic resin (A) contains a polymerization unit (a1) of a (meth)acrylate having an epoxy group and a polymerization unit (a2) of a (meth)acrylate having one or more non-epoxy groups, and the acrylic resin (A) has a weight average molecular weight of 50,000 or more and 3,000,000 or less.

### DETAILED DESCRIPTION

A stretchable film of the present embodiment is formed using a resin composition containing an acrylic resin (A) and a curing agent (B). In the resin composition, the acrylic resin (A) contains a polymerization unit (a1) of a (meth)acrylate having an epoxy group and a polymerization unit (a2) of a (meth)acrylate having one or more non-epoxy groups, and the acrylic resin (A) has a weight average molecular weight of 50,000 or more and 3,000,000 or less. The stretchable film of the present embodiment has an ultraviolet absorbance at 355 nm of 1.5 or more at a thickness of 100 μm and a glass transition temperature of 0° C. or higher and lower than 50° C.

The film of the present embodiment has stretchability at room temperature, flexibility, and excellent heat resistance. Since the film is excellent in processability such as UV (ultraviolet) laser, the film can be suitably used for a stretchable multilayer wiring board.

Hereinafter, specific embodiments of the present invention will be described, but the following embodiments are merely one of various embodiments of the present invention, and various modifications can be made according to the design as long as the object of the present invention can be achieved.

### (Resin Composition)

First, a resin composition for forming the stretchable film of the present embodiment will be described. The resin composition of the present embodiment contains at least an acrylic resin (A) and a curing agent (B).

### Acrylic Resin (A)

The acrylic resin in the present embodiment refers to a polymer compound obtained by subjecting a compound having one or more acryloyl groups or methacryloyl groups to a polymerization reaction. In the present embodiment, the acrylic resin serves as a binder and imparts flexibility to the cured product (film) of the composition.

The acrylic resin (A) of the present embodiment has a weight average molecular weight of 50,000 or more and 3,000,000 or less, and contains a polymerization unit (a1) of a (meth)acrylate having an epoxy group and a polymerization unit (a2) of a (meth)acrylate having one or more non-epoxy groups.

As the weight average molecular weight of the acrylic resin (A) used in the present embodiment is within the above range, it is possible to obtain a resin film which exhibit excellent flexibility (stretchability), tensile strength (breaking resistance) and resin flowability. The lower limit of the weight average molecular weight is more preferably 100,000 or more, and still more preferably 200,000 or more. Meanwhile, the upper limit is more preferably 2,000,000 or less, and still more preferably 1,000,000 or less.

The acrylic resin (A) of the present embodiment preferably does not have unsaturated bonds such as double bonds and triple bonds between carbon atoms. In other words, it is preferable that the carbon atoms of the acrylic resin (A) are bonded to each other by a saturated bond (single bond). By not having unsaturated bonds between carbon atoms, it is considered that the acrylic resin is not oxidized over time and can further maintain the elasticity.

The acrylic resin (A) of the present embodiment is a resin in which the polymerization unit (a1) and the polymerization unit (a2) are randomly polymerized.

The form of polymerization is not particularly limited, and the acrylic resin may be a block copolymer, an alternating copolymer, a random copolymer, or a graft copolymer or the like.

In the present embodiment, the polymerization unit (a1) of the (meth)acrylate having an epoxy group provides a crosslinking point to make the acrylic resin (A) of the present embodiment curable. It is considered that the acrylic resin (A) has an epoxy group, thereby improving the heat resistance of the cured product after heating and curing.

The content of the polymerization unit (a1) in the acrylic resin (A) is not particularly limited, but is preferably such that the epoxy equivalent weight of the polymerization unit (a1) with respect to the total amount of the acrylic resin (A) is about 500 g/eq or more and 5000 g/eq or less. As the epoxy equivalent weight is in such a range, it is considered that a resin composition exhibiting heat resistance and a proper elastic modulus is obtained more reliably. When the epoxy equivalent weight is less than 500 g/eq, the elastic modulus after curing becomes too high and breakage may occur during elongation. When the epoxy equivalent weight exceeds 5000 g/eq, the elastic modulus after curing at a high temperature becomes low, and for example, the film may be deformed in the reflow process, resulting in defective mounting. A more preferable range of the epoxy equivalent weight is 1000 g/eq or more and 3000 g/eq or less.

Specific examples of the (meth)acrylate monomer constituting the polymerization unit (a1) having an epoxy group include glycidyl (meth)acrylate, β-methylglycidyl (meth)acrylate, β-ethylglycidyl (meth)acrylate, glycidyl vinyl ether, o-vinylbenzyl glycidyl ether, m-vinylbenzyl glycidyl ether, p-vinylbenzyl glycidyl ether, o-isopropenylbenzyl glycidyl ether, m-isopropenylbenzyl glycidyl ether, and p-isopropenylbenzyl glycidyl ether. These may be used singly or in combination of two or more kinds thereof.

In the present embodiment, the acrylic resin contains a polymerization unit (a2) of a (meth)acrylate having one or more kinds of non-epoxy groups in addition to the polymerization unit (a1) described above.

Examples of the non-epoxy group include a cyano group, an isobornyl group, an ethyl group, a hydroxyethyl group, a butyl group, a methyl group, an ethylhexyl group, a cyclohexyl group, and a benzyl group, and the (meth)acrylate of the polymerization unit (a2) has one or two or more non-epoxy groups thereof. Preferably, the polymerization unit (a2) of the (meth)acrylate has a cyano group and/or an isobonyl group.

Specific examples of the (meth)acrylate monomer constituting the polymerization unit (a2) having a cyano group are not particularly limited, but the specific examples include acrylonitrile and methacrylonitrile. Specific examples of the acrylate or (meth)acrylate monomer constituting the polymerization unit (a2) having an isobornyl group are not particularly limited, but include isobornyl (meth)acrylate.

The resin composition of the present embodiment preferably contains the polymerization unit (a2) component in an amount of 70 parts by mass or more and 99 parts by mass or less with respect to 100 parts by mass of the acrylic resin (A). When the content is in this range, it is considered that the above-described effects can be obtained more reliably. A still more preferable content of the polymerization unit (a2) component is 80 parts by mass or more and 97 parts by mass or less with respect to 100 parts by mass of the acrylic resin (A).

The proportion of the acrylic resin (A) blended in the resin composition of the present embodiment is not particularly limited as long as the effects of the present invention such as flexibility and laser processability are obtained, but is, for example, preferably about 30 to 95 mass % with respect to the entire resin composition.

Furthermore, the resin composition of the present embodiment may contain a resin other than the acrylic resin (A), and an epoxy resin, a urethane resin, an acrylic resin, a fluororesin, and a silicone resin and the like can be further added depending on the purpose.

### Curing Agent (B)

The resin composition of the present embodiment further contains a curing agent (B). The curing agent (B) that can be used in the present embodiment is not particularly limited as long as it acts as an epoxy curing agent. Specifically, examples thereof include a phenol resin, an amine-based compound, an acid anhydride, an imidazole-based compound, a sulfide resin, a dicyandiamide, a mercapto-based compound, an onium salt, and a peroxide. A light/ultraviolet curing agent and a thermal cationic curing agent and the like can also be used. These may be used singly or in combination of two or more kinds thereof depending on the situation. Preferably, the curing agent of the present embodiment contains at least one selected from an acid anhydride, an amine-based curing agent, a phenol-based curing agent, and a carboxylic acid-based curing agent.

Among these, it is preferable to use an acid anhydride as the curing agent (B), and examples of the acid anhydride curing agent include maleic anhydride, succinic anhydride, itaconic anhydride, citraconic anhydride, phthalic anhydride, 1,2,3,6-tetrahydrophthalic anhydride, 3,4,5,6-tetrahydrophthalic anhydride, hexahydrophthalic anhydride, 4-methylhexahydrophthalic anhydride, 3-methyl-1,2,3,6-tetrahydrophthalic anhydride, 4-methyl-1,2,3,6-tetrahydrophthalic anhydride, and methyl-3,6-endo-methylene-1,2,3,6-tetrahydrophthalic anhydride.

Preferably, the curing agent (B) of the present embodiment desirably contains a polyfunctional acid anhydride having a functionality of two or more. There is thus an advantage that three-dimensional crosslinking can be achieved and deformation particularly at high temperatures can be suppressed. In addition, curing shrinkage can be diminished.

As the polyfunctional acid anhydride having a functionality of two or more, a commercially available product can be used, and examples thereof include RIKACID BT-100, TDA-100, and TBN-100 (all manufactured by New Japan Chemical Co., Ltd.) and ENEHYDE CpODA (manufactured by JXTG Nippon Oil & Energy Corporation).

In the resin composition of the present embodiment, the content of the curing agent (B) can be appropriately set according to the epoxy equivalent weight, and for example, the content of the curing agent (B) in the total amount of the resin composition is preferably 5 mass % or more and 70 mass % or less, and more preferably 7 mass % or more and 60 mass % or less.

### Ultraviolet Absorber (C)

The resin composition of the present embodiment preferably further contains an ultraviolet absorber (C). Thereby, excellent laser processability can be more reliably obtained.

The ultraviolet absorber (C) preferably contains a triazine derivative. Thereby, the compatibility of the ultraviolet absorber (C) in the resin composition is improved, and the UV absorption efficiency is further improved. Therefore, workability at the time of preparing a resin varnish using the resin composition of the present embodiment is improved, and laser processability also can be more reliably obtained.

Examples of the triazine derivative include 2,4,6-tris(2-hydroxy-4hexyloxy-3-methylphenyl)-1,3,5-triazine, 2-(2,4-dihydroxyphenyl)-4,6-bis(2,4-dimethylphenyl)-1,3,5-triazine, 2-(2,4-dihydroxyphenyl)-4,6-diphenyl-1,3,5-triazine, 2-(4,6-diphenyl-1,3,5-triazine-2-yl)-5-(hexyloxy)phenol, tri-(m-tolyl)-1,3,5-triazine-2,4,6-triamine, 2,4,6-tris(2,4-dihydroxyphenyl)-1,3,5-triazine, 2,4,6-tris(4-butoxy-2-hydroxyphenyl)-1,3,5-triazine, ethylhexyltriazine, 2-(2-hydroxy-4-methoxyphenyl)-4, 6-diphenyl-1,3,5-triazine, 2,4-bis(2,4-dimethylphenyl)-6-(2-hydroxy-4-n-octylloxyphenyl)-1,3,5-triazine, bemotridinol, 2-(2-hydroxy-4-(1-octylloxycarbonyllethyl)oxyphenyl)-4,6,-di(4-phenyl)phenyl-1,3,5-triazine, and 2-(4-)2-hydroxy-3-tridecyloxypropyl)oxy)-2-hydroxyphenyl)-4,6-bis)2,4-dimethylphenyl)-1,3,5-triazine.

Commercially available products may be used as the triazine derivative, and specific examples thereof include “Tinuvin 400”, “Tinuvin 477”, “Tinuvin 479”, and “Tinuvin 405” manufactured by BASF Japan Ltd.

The ultraviolet absorber (C) of the present embodiment preferably has a weight average molecular weight of 200 or more and 2000 or less from the viewpoint of the heat resistance of the film and the compatibility of the ultraviolet absorber (C) in the resin composition. The weight average molecular weight is more preferably 500 or more and 1500 or less.

In the present embodiment, the content of the ultraviolet absorber (C) in the total amount of the resin composition is preferably 0.2 mass % or more and 10 mass % or less. This is considered to make it possible to more reliably obtain the heat resistance of the film and the compatibility of the ultraviolet absorber (C) in the resin composition. The content is more preferably 1 mass % or more and 5 mass % or less, and still more preferably 1 mass % or more and 3 mass % or less.

Furthermore, the resin composition according to the present embodiment may contain other additives, for example, a curing accelerator (curing catalyst), a surfactant, a flame retardant, a flame retardant promoter, a leveling agent, a colorant, an infrared absorber, an antistatic agent, a conduction auxiliary, and inorganic fine particles if necessary as long as the effects of the present invention are not impaired.

The curing accelerator (curing catalyst) usable in the present embodiment is not particularly limited, but for example, imidazoles and derivatives thereof, organophosphorus-based compounds, metal soaps such as zinc octanoate, secondary amines, tertiary amines, and quaternary ammonium salts can be used. These may be used singly or in combination of two or more kinds thereof depending on the situation.

In the case of using a curing accelerator, it is preferable to use the curing accelerator so that the content thereof is 0.01 mass % or more and 3 mass % or less with respect to 100 parts by mass of the resin composition.

### (Preparation of Resin Composition and Film)

The stretchable film of the present embodiment is formed using the resin composition as described above. The method for preparing the resin composition of the present embodiment is not particularly limited, and for example, the acrylic resin (A), the curing agent (B), and if necessary, the ultraviolet absorber (C) and other additives are mixed with a solvent so as to be uniform. The solvent to be used is not particularly limited, and for example, toluene, xylene, methyl ethyl ketone, and acetone can be used. These solvents may be used singly or in combination of two or more kinds thereof. An organic solvent for adjusting the viscosity and various additives may be further blended if necessary.

The stretchable film of the present embodiment can be obtained by heating and drying the resin composition obtained as described above and evaporating the solvent.

The method and apparatus for heating and drying the resin composition and the conditions of these may be the same various units as conventional units or improved units thereof. The specific heating temperature and time can be appropriately set depending on the curing agent, solvent and the like used, but for example, the resin composition can be formed into a resin film by being heated and dried at 80° C. to 110° C. for about 5 to 15 minutes. Furthermore, a cured film in which the resin composition is completely cured may be obtained by heating and curing at 120° C. to 180° C. for about 20 to 60 minutes.

The stretchable film of the present embodiment may be composed only of the above-described resin composition or a semi-cured product thereof, but may be in the form of a resin-coated film including a resin layer containing the resin composition or a semi-cured product thereof, and a support (supporting film). Examples of the support include electrical insulating films such as a polyimide film, a PET (polyethylene terephthalate) film, a polyester film, a poly(parabanic acid) film, a polyether ether ketone film, a polyphenylene sulfide film, an aramid film, a polycarbonate film, and a polyarylate film.

The resin-coated film (resin sheet material) of the present embodiment may be a resin-coated film including the resin composition before curing (uncured) (the resin composition in A stage) and a support, or a resin-coated film including a semi-cured product of the resin composition (the resin composition in B stage) and a support.

As the method for producing such a resin-coated film, for example, a resin composition in the form of a resin varnish as described above is applied to the surface of a film support substrate, and then the solvent is volatilized from the varnish and diminished or removed, whereby a resin-coated film before curing (in A stage) or in a semi-cured state (B stage) can be obtained.

In the present embodiment, the “semi-cured product” is one in a state where the resin composition is partly cured so as to be further cured. In other words, the semi-cured product is the resin composition in a semi-cured state (B-staged). For example, when a resin composition is heated, the viscosity of the resin composition first gradually decreases, then curing starts, and the viscosity gradually increases. In such a case, the semi-cured state includes a state where the viscosity has started to increase but curing is not completed, and the like.

### (Stretchable Film)

The stretchable film of the present embodiment has an ultraviolet absorbance at 355 nm of 1.5 or more at a thickness of 100 μm and a glass transition temperature of 0° C. or higher and lower than 50° C. With such a configuration, the stretchable film of the present embodiment has stretchability at room temperature, flexibility, and excellent heat resistance and processability of UV (ultraviolet) laser or the like.

The ultraviolet absorbance is a value measured in the cured stretchable film, and is a value obtained by ultraviolet/visible spectroscopy (Ultraviolet-Visible Absorption Spectroscopy: UV-VIS). A more preferable range of the ultraviolet absorbance is 1.5 or more.

The glass transition (Tg) temperature is also a value measured in the cured stretchable film, and is a value obtained by a method described in Examples to be described later.

In the present embodiment, the terms “stretchable” and “flexible” mean that the elongation rate of the film (alternatively, the cured product of the resin composition) until breakage is 5.0% or more, preferably 10% or more, more preferably 25% or more, still more preferably 50% or more, and most preferably 100% or more. The upper limit value of the elongation rate is not particularly required to be provided, but it is preferable that the elongation rate does not exceed 500% from the viewpoint that the original shape is impaired when the cured product is elongated more than necessary. This also means that the tensile modulus of the film of the present embodiment (alternatively, the cured product of the resin composition) at room temperature of 25° C. is 0.1 MPa or more and 0.5 GPa or less, preferably 1 MPa or more and 300 MPa or less, and more preferably 5 MPa or more and 100 MPa or less. The values of “elongation rate until breakage” and “tensile modulus at room temperature of 25° C.” in the present embodiment are values obtained by the following method.

First, each of the films is cut into a dumbbell No. 6 (JIS K 6251, 2017) and attached to a universal testing machine (AGS-X manufactured by Shimadzu Corporation). The test is performed at a tension speed of 25 mm/min, the slope of r-σ is determined from all stress (σ) data corresponding to strain (r) from 0 to 0.05 by the least squares method, and the initial tensile modulus is calculated.

Strain (r)=x/x0 (x is the gripper moving distance, x0 is the initial distance between grippers)

Stress (σ)=F/(d·l) (F is test force, d is film thickness, and l is width of test piece)

The “elongation rate until breakage” in the present embodiment is represented by a breaking elongation rate (%), and can be obtained by measuring the elongation rate when the resin film is broken with the tester.

The stretchable film of the present embodiment may be a cured product obtained by completely curing the resin composition as described above or a semi-cured product obtained by semi-curing the resin composition. In the case of a cured film, it is preferable that the film has adhesive performance with a peel strength of 0.5 N/mm or more. By having such a peel strength, the stretchable film of the present embodiment is excellent in adhesiveness in addition to flexibility and heat resistance, and can be suitably used for the purpose of multilayering, circuit protection, and the like.

The thickness of the stretchable film of the present embodiment is not particularly limited, but is preferably 10 μm or more and 200 μm or less from the viewpoint of an electronic substrate, lamination of the electronic substrate, and handling in production, and the like. The film thickness is more preferably 25 μm or more and 100 μm or less.

### (Application of Stretchable Film)

The stretchable film of the present embodiment can be used as a material or a substrate for various electronic components and the like in various applications. In particular, since the stretchable film is excellent in flexibility, adhesion, and laser processability, the stretchable film is very suitable as a circuit material used for devices such as smartphones, sensors, flat cables, and wearable devices that require two or more layers of high-density wiring, for example.

The stretchable film of the present embodiment may include a metal foil on at least one surface. That is, the present embodiment also includes a resin-coated metal foil, a metal-clad laminate, and a wiring board and the like obtained using the stretchable film.

The resin-coated metal foil of the present embodiment includes a resin layer containing the film described above and a metal foil superimposed on the resin layer. That is, the resin-coated metal foil has a configuration in which the metal foil is laminated on at least one surface of the stretchable film. The metal foil may be present on both sides of the resin layer. The resin-coated metal foil of the present embodiment may be a resin-coated metal foil including a resin layer containing the resin composition before curing (the resin composition in A stage) and a metal foil, or a resin-coated metal foil including a resin layer containing a semi-cured product of the resin composition (the resin composition in B stage) and a metal foil.

Examples of the method for producing such a resin-coated metal foil include a method in which a resin composition in the form of a resin varnish as described above is applied to the surface of a metal foil such as a copper foil and then dried. Examples of the coating method include a bar coater, a comma coater, a die coater, a roll coater, and a gravure coater.

As the metal foil, metal foils used in common metal-clad laminates, wiring boards and the like can be used without limitation, and examples thereof include a copper foil and an aluminum foil. The thickness and the like of such a metal foil can be appropriately set according to a desired purpose.

The drying or heat-drying conditions in the method for producing a resin-coated metal foil are not particularly limited, but can be equivalent to the drying or heat-drying conditions in the method for producing a film described above.

The resin-coated metal foil may include a cover film or the like if necessary. By including a cover film, it is possible to prevent foreign matter from entering. The cover film is not particularly limited as long as it can be peeled off without damaging the form of the resin composition, and for example, a polyolefin film, a polyester film, a TPX film, films formed by providing a mold releasing agent layer on these films, and paper obtained by laminating these films on a paper substrate can be used.

The metal-clad laminate included in the present embodiment includes an insulating layer containing the above-described stretchable film or a cured product of the above-described resin composition, and a metal foil superimposed on the insulating layer. As the metal foil used in the metal-clad laminate, those the same as the metal foils described above can be used.

As the metal-clad laminate of the present embodiment, for example, one or a plurality of the stretchable films are superimposed one on another, and a metal foil such as a copper foil is further superimposed on both upper and lower sides or on one side, and this is laminated and integrated by heat and press molding, whereby a double-sided metal foil clad or single-sided metal foil clad laminate can be produced. The heating and pressing conditions can be appropriately set depending on the thickness of the laminate to be produced, and the kind of the resin composition, and the like, but for example, the temperature may be set to 150° C. to 220° C., the pressure may be set to 0.1 to 3.0 MPa, and the time may be set to 60 to 180 minutes.

The wiring board included in the present embodiment includes an insulating layer containing the above-mentioned stretchable film or a cured product of the above-mentioned resin composition, and a wiring. The wiring is provided on at least one selected from the surface or inside of the insulating layer.

The stretchable film of the present embodiment is suitably used as a material of an insulating layer of a multilayer wiring board produced by a build-up method. As the method for producing the wiring board, for example, the metal foil on the surface of the metal-clad laminate obtained above is etched to form a circuit (wiring), whereby a wiring board having a conductor pattern (wiring) provided as a circuit on the surface of the laminate can be obtained. Examples of the circuit forming method include circuit formation by a semi additive process (SAP) or a modified semi additive process (MSAP) in addition to the method described above.

The resin-coated metal foil, the metal-clad laminate, and the wiring board obtained using the stretchable film of the present embodiment are excellent in flexibility, heat resistance, and adhesion, and also excellent in laser processability, and thus are extremely useful in industrial applications.

This specification discloses techniques in various aspects as described above, and the main techniques among them are summarized below.

A stretchable film according to a first aspect of the present invention is formed by using a resin composition containing an acrylic resin (A) and a curing agent (B), wherein the stretchable film has an ultraviolet absorbance at 355 nm of 1.5 or more at a thickness of 100 μm, the stretchable film has a glass transition temperature of 0° C. or higher and lower than 50° C., and
in the resin composition, the acrylic resin (A) contains a polymerization unit (a1) of a (meth)acrylate having an epoxy group and a polymerization unit (a2) of a (meth)acrylate having one or more non-epoxy groups, and the acrylic resin (A) has a weight average molecular weight of 50,000 or more and 3,000,000 or less.

A stretchable film according to a second aspect is the stretchable film according to the first aspect, wherein the resin composition further contains an ultraviolet absorber (C).

A stretchable film according to a third aspect is the stretchable film according to the second aspect, wherein the ultraviolet absorber (C) contains a triazine derivative.

A stretchable film according to a fourth aspect is the stretchable film according to the second or third aspect, wherein a content of the ultraviolet absorber (C) in a total amount of the resin composition is 0.2 mass % or more and less than 10 mass %.

A stretchable film according to a fifth aspect is the stretchable film according to any one of the second to fourth aspects, wherein the ultraviolet absorber (C) has a weight average molecular weight of 500 or more and 1000 or less.

A stretchable film according to a sixth aspect is the stretchable film according to any one of the first to fifth aspects, wherein the acrylic resin (A) has an epoxy equivalent weight of 1000 g/eq or more and 5000 g/eq or less.

A stretchable film according to a seventh aspect is the stretchable film according to any one of the first to sixth aspects, wherein a content of the curing agent (B) in a total amount of the resin composition is 5 mass % or more and 30 mass % or less.

A stretchable film according to an eighth aspect is the stretchable film according to any one of the first to seventh aspects, wherein the stretchable film has adhesive performance with a peel strength of 0.5 N/mm or more.

A stretchable film according to a ninth aspect is the stretchable film according to any one of the first to eighth aspects, wherein the stretchable film includes a metal foil on at least one surface.

A stretchable multilayer wiring board according to a tenth aspect is formed using the stretchable film according to any one of the first to ninth aspects.

Hereinafter, the present invention will be described more specifically with reference to Examples, but the scope of the present invention is not limited thereto.

### EXAMPLES

First, all kinds of materials used in the present Examples are as follows.

### <Acrylic Resin (A)>

### Preparation of Acrylic Resin

Acrylonitrile and isobornyl acrylate as a polymerization unit (a2), and a polymerization unit represented by the following formula (1) were blended at a blending ratio (polymerization %) of 10:20:70. To the blended product, glycidyl methacrylate was added as a polymerization unit (a1) so that an epoxy equivalent weight based on the total amount of an acrylic resin was 1818 g/eq. After that, the mixture was subjected to the polymerization reaction to obtain an acrylic resin 1 containing methyl ethyl ketone as a solvent (“PMS-14-67” manufactured by Nagase ChemteX Corporation, weight average molecular weight 290,000). The solid ratio was 40% by weight.

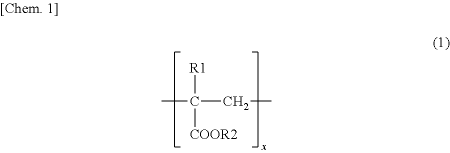

In formula (1), R1 is hydrogen or a methyl group and R2 is hydrogen or an alkyl group. X represents an integer.

### <Curing Agent (B)>

Acid anhydride (“RIKACID TBN-100” available from New Japan Chemical Co., Ltd.)

### <Ultraviolet Absorber (C)>

### (Ultraviolet Absorber (C) Containing Triazine Derivative)

Ultraviolet absorber 1: 2,4,6-tris(2-hydroxy-4-hexyloxy-3-methylphenyl)-1,3,5-triazine (Product name “LA-F70”, manufactured by ADEKA Corporation, weight average molecular weight: 700)
Ultraviolet absorber 2: 2-[4,6-bis(2,4-dimethylphenyl)-1,3,5-triazine-2-yl]-5-[3-(dodecyloxy)-2-hydroxypropoxy]phenol (Product name “Tinuvin 400”, manufactured by BASF Japan Ltd., weight average molecular weight: 1293)
Ultraviolet absorber 3: Black dye (Product name “RN-1”, manufactured by Chuo Synthetic Chemical Co., Ltd., weight average molecular weight of mixture: 500 to 1000)
Ultraviolet absorber 4: 7-diethylamino-4-methylcoumarin (weight average molecular weight: 231)
Ultraviolet absorber 5: Pyrazoline-based colorant (Product name “HR-101”, manufactured by Chuo Synthetic Chemical Industry Co., Ltd., weight average molecular weight: 231)
Ultraviolet absorber 6: 2,3-dimethyl-4-(dimethylamino)-1-phenyl-3-pyrazoline-5 one (weight average molecular weight: 203)

### <Curing Catalyst>

Imidazole-based curing catalyst “2PZ-CN” (manufactured by Shikoku Chemicals Corporation)

### [Method for Preparing Resin Composition]

Various components were blended based on blending ratios (parts by mass) shown in Table 1 to prepare mixtures of formulations 1 to 13. Methyl ethyl ketone was used as a carrier solvent, and a solid concentration in the mixture was adjusted to 35%. The mixture was stirred at 1000 RPM for 10 minutes using a homodisper to obtain a solution of a resin composition (resin varnish).

TABLE 1

| | | Formu- | Formu- | Formu- | Formu- | Formu- | Formu- | Formu- | Formu- | Formu- | Formu- | Formu- | Formu- | Formu- |
|---|---|---|---|---|---|---|---|---|---|---|---|---|---|---|
| | | lation | lation | lation | lation | lation | lation | lation | lation | lation | lation | lation | lation | lation |
| | | 1 | 2 | 3 | 4 | 5 | 6 | 7 | 8 | 9 | 10 | 11 | 12 | 13 |
| Acrylic | Acrylic | 89.0% | 89.0% | 89.0% | 89.0% | 89.4% | 89.2% | 88.6% | 88.2% | 87.3% | 89.8% | 89.0% | 89.0% | 89.6% |
| resin (A) | resin | | | | | | | | | | | | | |
| Curing | Acid | 9.1% | 9.1% | 9.1% | 9.0% | 9.1% | 9.0% | 9.0% | 8.9% | 8.9% | 9.2% | 9.1% | 9.1% | 9.1% |
| agent (B) | anhydride | | | | | | | | | | | | | |
| Curing | Imidazole - | 1.0% | 1.0% | 1.0% | 1.0% | 1.0% | 1.0% | 1.0% | 1.0% | 0.9% | 1.0% | 1.0% | 1.0% | 1.0% |
| catalyst | based curing | | | | | | | | | | | | | |
| | catalyst | | | | | | | | | | | | | |
| Ultraviolet | Ultraviolet | | | | | | | | | | | 1.0% | | |
| absorber | absorber 4 | | | | | | | | | | | | | |
| (C) | Ultraviolet | | | | | | | | | | | | 1.0% | |
| | absorber 5 | | | | | | | | | | | | | |
| | Ultraviolet | 1.0% | | | | | | | | | | | | |
| | absorber 3 | | | | | | | | | | | | | |
| | Ultraviolet | | 1.0% | | | | | | | | | | | |
| | absorber 6 | | | | | | | | | | | | | |
| | Ultraviolet | | | 1.0% | | | | | | | | | | |
| | absorber 2 | | | | | | | | | | | | | |
| | Ultraviolet | | | | 1.0% | 0.5% | 0.7% | 1.5% | 1.9% | 2.9% | | | | 0.3% |
| | absorber 1 | | | | | | | | | | | | | |

### Preparation of Samples for Evaluation of Laser Processability

Of the obtained resin varnishes, each of the resin varnishes of the formulations 1 to 4 and the formulations 10 to 13 was applied onto a copper foil (manufactured by Fukuda Metal Foil & Powder Co., Ltd., thickness: 18 μm), and dried at 100° C. for 10 minutes to remove the solvent. Thereafter, the resin varnish was heated and cured at 170° C. for 90 minutes to obtain a resin-coated copper foil (film including copper foil) including a cured resin layer with a thickness of 100 μm.

### (Evaluation of Laser Processability)

The samples of Examples 1 to 4 and Comparative Examples 1 to 4 (films provided with copper foils) were subjected to drilling with a laser (“UV-YAG laser”, manufactured by Esi Japan Co., Ltd.) under the same conditions, and the hole diameter was measured by observing the cross section with an optical microscope. The diameter of an upper surface hole (upper surface diameter) and the diameter of a lower surface hole (bottom surface diameter) were measured, and the ratio of the upper surface diameter to the bottom surface diameter was determined. In this test, when the ratio of the bottom surface diameter to the upper surface diameter was 0.5 or more, the ratio was determined to be acceptable.

### (Ultraviolet Absorbance)

All the copper foils were removed from the samples (films) of Examples 1 to 4 and Comparative Examples 1 to 4 by etching, and sufficiently dried, and then the absorbance at 355 nm (ultraviolet ray) was measured by a spectrophotometer (U-4100, manufactured by Hitachi High-Technologies Corporation).

### (Glass Transition Temperature)

The glass transition temperature of the cured film was measured by DMS6100 (manufactured by SII NanoTechnology Inc.). The measured thickness was 50 μm.

The above results are summarized in Table 2.

TABLE 2

| | | | | | | Comparative | Comparative | Comparative | Comparative |
|---|---|---|---|---|---|---|---|---|---|
| | | Example 1 | Example 2 | Example 3 | Example 4 | Example 1 | Example 2 | Example 3 | Example 4 |
| | | Resin composition formulation number | | | | | | | |
| | | Formu- | Formu- | Formu- | Formu- | Formu- | Formu- | Formu- | Formu- |
| | | lation 1 | lation 3 | lation 4 | lation 13 | lation 2 | lation 10 | lation 11 | lation 12 |
| Absorbance at 355 nm (ultraviolet rays) | | 1.526 | 2.347 | 2.878 | 1.513 | 1.039 | 0.431 | 1.107 | 1.009 |
| Laser | Upper surface diameter (μm) | 64.5 | 60.7 | 51.5 | 55.5 | 57.3 | 54.8 | — | — |
| processing | Bottom surface diameter (μm) | 38.7 | 53.3 | 45.7 | 36.2 | Not | Not | — | — |
| | | | | | | penetrate | penetrate | | |
| | Diameter ratio of | 0.60 | 0.88 | 0.89 | 0.65 | — | — | — | — |
| | bottom surface/upper | | | | | | | | |
| | surface | | | | | | | | |

| | | | | | | | | |
|---|---|---|---|---|---|---|---|---|
| Glass transition temperature | 36 | 35 | 36 | 39 | 36 | 43 | 36 | 36 |

### (Evaluation of Solubility)

In the resin varnishes of the formulations 1 to 13 prepared above, the dissolution time of the ultraviolet absorber was measured, and a time until dissolution was measured and evaluated as a dissolution time. The formulation that did not dissolve even after 10 minutes was evaluated as rejection. The results are shown in Table 3.

TABLE 3

| | Formu- | Formu- | Formu- | Formu- | Formu- | Formu- | Formu- | Formu- | Formu- | Formu- | Formu- | Formu- | Formu- |
|---|---|---|---|---|---|---|---|---|---|---|---|---|---|
| | lation | lation | lation | lation | lation | lation | lation | lation | lation | lation | lation | lation | lation |
| | 1 | 2 | 3 | 4 | 5 | 6 | 7 | 8 | 9 | 10 | 11 | 12 | 13 |
| Dissolution time | x | 3 min | 4.5 min | 3 min | 2.5 min | 3 min | 3.5 min | 4.5 min | 10 min | — | 0 min | 0.5 min | 2.5 min |

### DISCUSSION

In the samples of Examples 1 to 4, it was confirmed that the ultraviolet absorbance at 355 nm was 1.5 or more, and the lasers penetrated all the samples. From this result, it was confirmed that the stretchable film of the present embodiment can provide a material having excellent processability while having stretchability.

In one Comparative Example, the absorbance at 355 nm was low, and even laser processing could not penetrate the samples.

In the resin composition of Comparative Example 1, a pyrazoline-based derivative was used as the ultraviolet absorber, and it was found that when the pyrazoline-based derivative was used, a sufficient absorption efficiency of 355 nm ultraviolet rays could not be obtained.

In Comparative Example 2, no ultraviolet absorber was added, and in this case, it was confirmed that the ultraviolet absorbance was significantly low.

In Comparative Examples 3 and 4, a pyrazoline-based compound was used, and the absorption efficiency when the compound was formed into a varnish was lower than that of the triazine-based compound, and the addition amount was insufficient in the formulation of the triazine-based compound, and thus a sufficient absorption efficiency of 355 nm ultraviolet rays could not be obtained, and regarding laser processability, laser light was transmitted, and processing could not be performed.

As for the solubility of the ultraviolet absorber, as shown in Table 3, all the solutions were uniform except that a black dye was used in the formulation 1, but the black dye was not completely dissolved. In the formulation 9, the longest time was taken until the ultraviolet absorber was dissolved. The formulation 1 was dark in color and almost black. The formulation 2 was clear yellow, and the others were pale yellow to clear. From the results in Table 3, it was found that when the ultraviolet absorber was contained in an appropriate content, the compatibility between the acrylic resin and the ultraviolet absorber was excellent, and the workability in preparing the resin varnish was improved.

This application is based on Japanese Application No. 2023-200522 filed in the Japanese Patent Office on Nov. 28, 2023, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A stretchable film formed by using a resin composition containing an acrylic resin (A) and a curing agent (B), wherein
the stretchable film has an ultraviolet absorbance at 355 nm of 1.5 or more at a thickness of 100 μm,
the stretchable film has a glass transition temperature of 0° C. or higher and lower than 50° C., and
in the resin composition, the acrylic resin (A) contains a polymerization unit (a1) of a (meth)acrylate having an epoxy group and a polymerization unit (a2) of a (meth)acrylate having one or more non-epoxy groups, and the acrylic resin (A) has a weight average molecular weight of 50,000 or more and 3,000,000 or less.

2. The stretchable film according to claim 1, wherein the resin composition further contains an ultraviolet absorber (C).

3. The stretchable film according to claim 2, wherein the ultraviolet absorber (C) contains a triazine derivative.

4. The stretchable film according to claim 2, wherein a content of the ultraviolet absorber (C) in a total amount of the resin composition is 0.2 mass % or more and less than 10 mass %.

5. The stretchable film according to claim 2, wherein the ultraviolet absorber (C) has a weight average molecular weight of 500 or more and 1000 or less.

6. The stretchable film according to claim 1, wherein the acrylic resin (A) has an epoxy equivalent weight of 1000 g/eq or more and 5000 g/eq or less.

7. The stretchable film according to claim 1, wherein a content of the curing agent (B) in a total amount of the resin composition is 5 mass % or more and 30 mass % or less.

8. The stretchable film according to claim 1, wherein the stretchable film has adhesive performance with a peel strength of 0.5 N/mm or more.

9. The stretchable film according to claim 1, wherein the stretchable film includes a metal foil on at least one surface.

10. A stretchable wiring board formed using the stretchable film according to claim 1.

11. The stretchable wiring board according to claim 10, wherein the stretchable wiring board has a multilayer structure.
